(19) United States
(12) Patent Application Publication
(10) Pub. No.: US 2025/0305607 A1
(43) Pub. Date: Oct. 2, 2025

(54) Rotary Joint with Adjustable Syphon for Rotating Cylinder

(71) Applicant: Kadant Johnson LLC., Three Rivers, MI (US)

(72) Inventor: Timothy N. Henry, Marcellus, MI (US)

(73) Assignee: Kadant Johnson LLC, Three Rivers, MI (US)

(21) Appl. No.: 18/624,660

(22) Filed: Apr. 2, 2024

(51) Int. Cl. F16L 27/08; F28F 5/02; F28F 9/02

(52) U.S. Cl. CPC F16L 27/0808; F28F 5/02; F28F 9/0256

(57) ABSTRACT

A rotary joint for connecting a stationary portion to a rotating portion. An inlet passageway extends through the stationary portion and into the rotating portion for directing pressurized fluid to inside a rotating drum of the rotating portion. A stationary syphon tube is disposed within the stationary portion and the rotating portion and in communication with a vacuum source, wherein the syphon tube has an inlet port positioned within the rotating drum. An outlet passageway extends through the syphon tube and in communication with the inlet port for removing condensate from the rotating drum. An adjustment mechanism is at least partially disposed within the stationary portion of the rotary joint for adjusting the distance between the inlet port of the syphon tube and an inner surface of the rotating drum without the need for stopping and/or depressurizing the rotating drum.

### FIELD OF THE INVENTION

The present disclosure relates to rotary joints for supplying a heat transfer medium to rotating heat transfer drums using stationary syphons for removing condensate from the rotating heat transfer drum for use primarily in the paper manufacturing industry, and in particular, an adjustment mechanism housed in the rotary joint for adjusting the position of the stationary syphon within the rotating heat transfer drum without the need for stopping and/or depressurizing the rotating heat transfer drum and/or the rotary joint.

### BACKGROUND

Rotating heat transfer drums such as the type used in the manufacture of paper, corrugated paper, and cardboard, usually employ steam to heat the drum, wherein a rotary joint located at the end of a hollow drum journal is used to introduce steam into the interior of the drum. As the steam condenses within the drum, the condensate is removed through a rotary joint, usually the same rotary joint that introduces the steam to the drum. It is well known to provide rotary joints with an inlet to introduce steam into the drum while also providing an outlet that allows for the removal of condensate through a syphon system.

Syphon systems for removing condensate from rotating heat transfer drums are either of the “rotating” type, wherein the conduit pickup occurs at a shoe contacting the drum interior, and the syphon structure rotates within the drum, or the syphon system may be of the “stationary” type wherein the condensate pickup structure extends into the drum interior but does not rotate with the drum and includes a condensate pickup port disposed adjacent the drum shell interior. Whether a heat transfer drum employs a rotating syphon system or a stationary syphon system depends on various factors including cost, size of the drum, rate of drum rotation, material to be heated, and other factors. Both types of systems are well known in the dryer drum art.

The creation and accumulation of condensate in the lower region of the dryer drum can create problems in the manufacture of paper, corrugated paper, and cardboard. The condensate accumulation “tumbles” within the dryer drum as the dryer drum rotates thereby requiring excessive power to rotate the drum while affecting the heat transfer from the steam within the drum to the drum shell. At higher rotational speeds, this condensate forms a film throughout the inner periphery of the drum and can be effectively removed by a rotating syphon system wherein the condensate film is removed and maintained at a minimum thickness. With a stationary syphon system, condensate is only removed at the lower region of the drum, wherein the condensate accumulates if the drum rate of rotation is not high enough to cause the condensate to “film” about the inner periphery of the drum.

Because of the “insulation” effect that condensate accumulation has on the heat transfer from the steam to the drum, it is particularly important when manufacturing corrugated fluted paper and cardboard to be able to accurately maintain the temperature of the drum closely to accurately control the humidity content of the paper being dried by the drum. Stationary syphon systems often fail to achieve the desired distance between the syphon pipe intake and the drum shell interior surface thereby prohibiting the optimum uniform heat transfer characteristics and control of the drum. Prior stationary syphon systems required that the spacing of the syphon pipe intake from the drum interior surface be determined by regulating the length of the syphon pipe, but due to manufacturing tolerances in the manufacture of the drum and variations in rotary joint installations, sub-optimal spacing often exists between the syphon intake entrance and the inner surface of the drum shell than is desired, resulting in an undesirable amount of condensate and uneven heating of the drum shell.

Thus, it is necessary to adjust and maintain the position of the syphon pipe intake relative to the drum interior surface to ensure that the optimal amount of condensate is removed from the interior of the drum. To accomplish this task, a considerable amount of installation work may be required within the drum interior when installing the rotating syphon system. This is a not a problem with larger dryers which have access openings located in the ends of the drums. However, such installation requires that the paper manufacturing system be completely shut down so that the interior of the drum can be accessed by service personnel. This also requires that the drum be depressurized and stopped which creates inefficiencies that are undesirable in an industrial environment.

With smaller size drums, it is usually necessary to employ stationary syphon systems whereby the syphon structure may be inserted through the hollow drum journal and into the drum. Once inserted, the syphon pipe portion of the syphon system is moved to an operating location adjacent the inner surface of the drum shell for removing condensate therefrom. Previously known adjustment mechanisms for smaller size drums allow for the adjustment of the syphon pipe inlet relative to the drum interior surface from both inside and outside the drum; however, such adjustment mechanisms all require that the drum be depressurized and stopped which create inefficiencies that are undesirable in an industrial environment.

It would be desirable to provide a rotary joint having an adjustment mechanism for adjusting the distance between a syphon pipe intake and the interior surface of a rotating dryer drum in the paper manufacturing industry to optimize the condensate layer of the dryer drum without having to depressurize and/or stop the rotation of the dryer drum thereby providing a more efficient syphon adjustment mechanism than conventional designs.

### SUMMARY OF THE DISCLOSURE

The present disclosure relates to a rotary joint that connects a stationary portion to a rotating portion for communicating a pressurized fluid to a rotating drum. The rotary joint has an inlet passageway that extends through the stationary portion and into the rotating portion for directing the pressurized fluid to inside the rotating drum. A syphon tube is disposed within the stationary portion and the rotating portion, is in communication with a vacuum source, and has an inlet port positioned within the rotating drum. An outlet passageway extends through the syphon tube and is in communication with an outlet port in the stationary portion and the inlet port in the syphon tube for removing condensate from the rotating drum. An adjustment mechanism is at least partially disposed within the stationary portion for adjusting the distance between the inlet port of the syphon tube and an inner surface of the drum without the need for stopping the rotation of the rotating drum and/or depressurizing the drum.

The syphon tube of the rotary joint is stationary and includes a primary syphon tube that extends through the stationary portion and at least a portion of the rotating portion wherein the primary syphon tube has a longitudinal axis that is parallel to a longitudinal axis of the stationary portion. The syphon tube further includes a secondary syphon tube in communication with the primary syphon tube wherein the secondary syphon tube has an inlet port located within the rotating drum. At least a portion of the syphon tube is disposed within the inlet passageway.

The adjustment mechanism of the rotary joint comprises an annular adjustment ring housed within the stationary portion and moveable in a direction transverse to a longitudinal axis of the stationary portion, wherein the adjustment ring is coupled to the syphon tube. An adjuster is at least partially disposed within the stationary portion and coupled to the adjustment ring wherein the adjuster may reciprocally move the adjustment ring and the syphon tube transverse to the longitudinal axis of the stationary portion thereby reciprocally adjusting the distance between the inlet port of the syphon tube and the inner surface of the rotating drum.

The adjuster may comprise an adjustment screw that threadedly engages a bore in the stationary portion wherein reciprocal rotation of the adjustment screw reciprocally moves the adjustment ring and the syphon tube transverse to the longitudinal axis of the stationary portion thereby reciprocally adjusting the distance between the inlet port of the syphon tube and the inner surface of the rotating drum. The adjustment screw may have an outwardly extending portion extending outwardly away from the stationary portion. A knob is connected to the outwardly extending portion of the adjustment screw to allow for reciprocal rotation of the adjustment screw by a user.

The adjustment ring of the rotary joint may have a through bore and a slot extending along a longitudinal axis parallel to the longitudinal axis of the adjustment ring. The adjuster may have a neck formed thereon and a head integral with and larger than the neck formed on a free end of the adjuster. The neck is received by the slot of the adjustment ring, and the head is received by the through bore in the adjustment ring to capture the head in the adjustment ring thereby allowing the adjuster to connect to the adjustment ring for reciprocal movement of the adjustment ring. The adjustment ring may have a conical surface formed on an inside diameter of the adjustment ring; and the syphon tube may have a conical surface formed on the outside diameter of the syphon tube wherein the conical surface on the syphon tube complementarily engages the conical surface on the adjustment ring. A nut having a threaded outside diameter threadedly engages threads on an inner diameter of the syphon tube. The threads on the inside diameter of the syphon tube are adjacent the conical surface formed on the outside diameter of the syphon tube to maintain engagement of the conical surfaces on the adjustment ring and the syphon tube. A flange is integral with and extends radially outward from the nut, and a spacer is positioned between and engages the flange of the nut and the adjustment ring to maintain engagement of the conical surfaces of the syphon tube and the adjustment ring.

### BRIEF DESCRIPTION OF THE DRAWINGS

The present disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a cross-sectional view of a rotary joint having an adjustable syphon within a rotating drum of the present disclosure;

FIG. 2 is a cross-sectional view taken in the direction of arrows 2-2 of FIG. 1 of the rotating drum of the present disclosure;

FIG. 3 is a cross-sectional view of the rotary joint of the present disclosure;

FIG. 4 is front plan view of the stationary portion of the rotary joint of the present disclosure;

FIG. 5A is a side plan view of the syphon adjustment mechanism of the rotary joint of the present disclosure;

FIG. 5B is a cross-sectional view of the syphon adjustment mechanism of the rotary joint of the present disclosure;

FIG. 6 is a perspective view of the syphon adjustment mechanism of the rotary joint of the present disclosure; and.

FIG. 7 is a cross-sectional view of the rotary joint of the present disclosure having a bent syphon tube.

### DETAILED DESCRIPTION

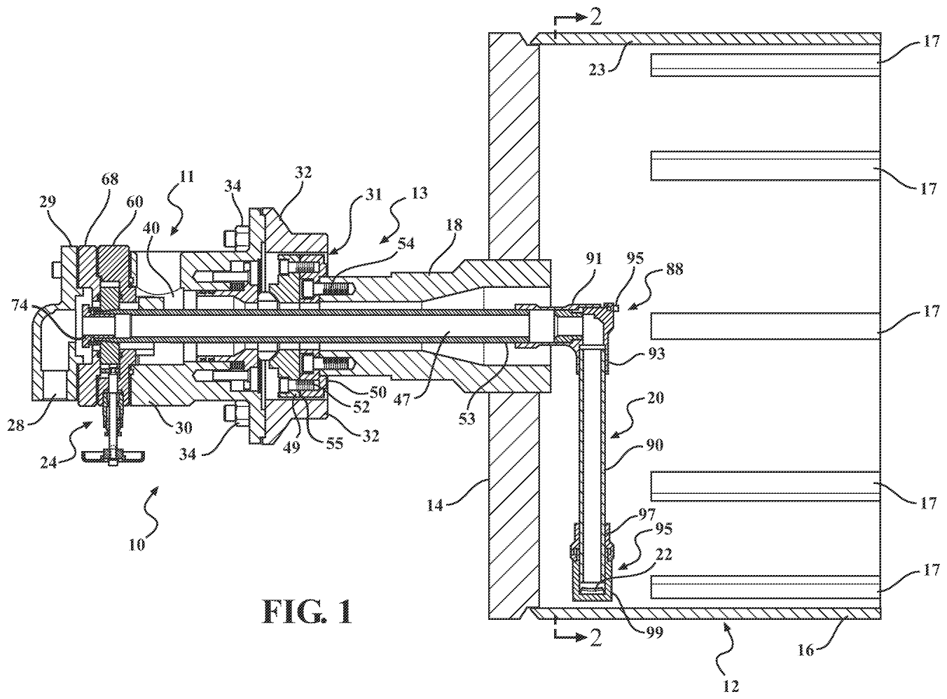

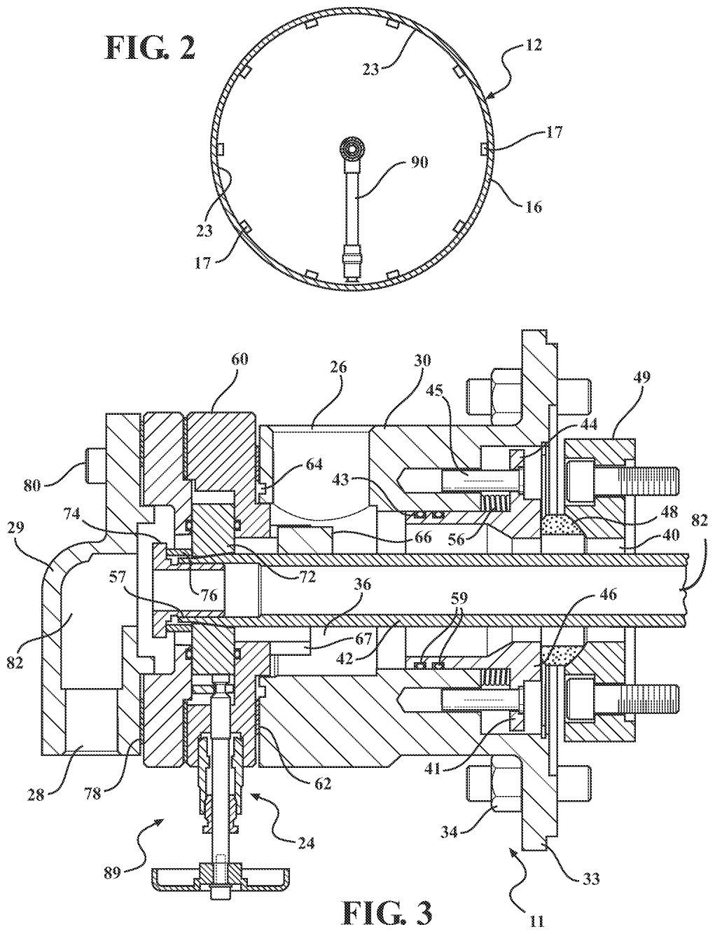

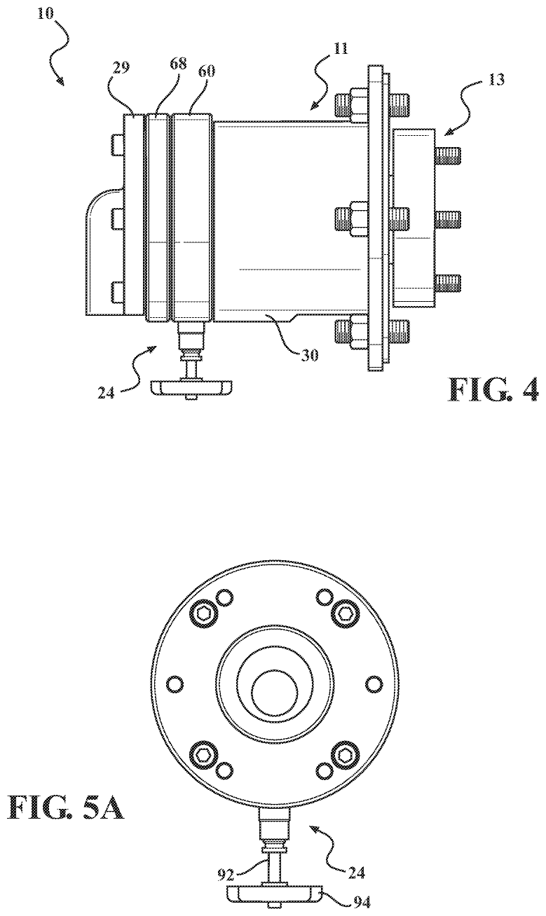

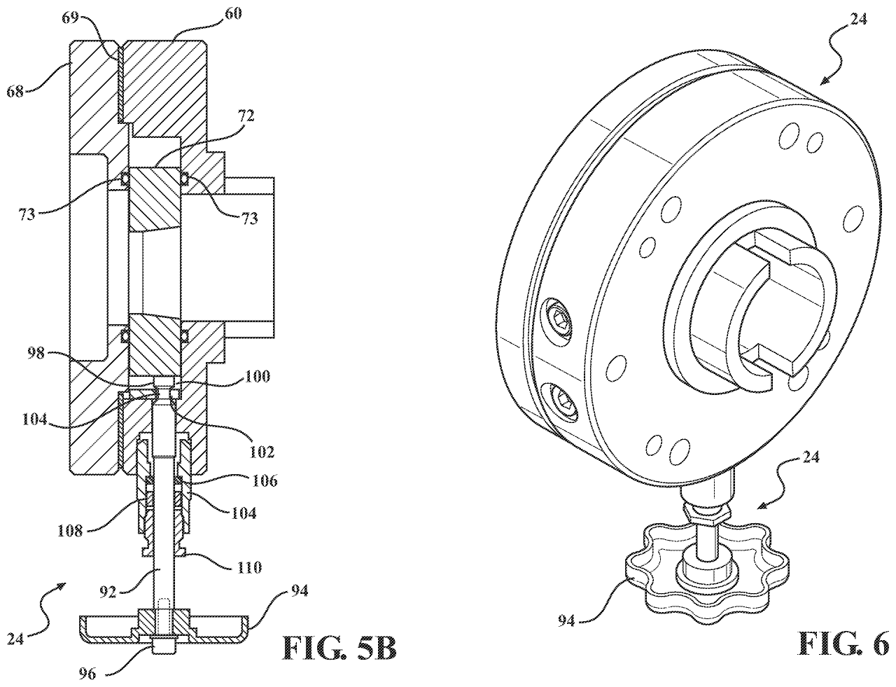

The present disclosure relates to a rotary joint 10 which may be used in combination with a rotating drying cylinder or heat transfer drum 12 such as used in the manufacture of paper, corrugated paper, and cardboard, as seen in FIGS. 1-6. The rotary joint 10 provides a sealed connection between a stationary portion 11 and a rotating portion 13 to communicate pressurized steam, water, and air to and from the rotating drum 12. The drum 12 includes a first radially extending drum end wall 14 connected to a periphery or shell of the drum 12 which is defined by a cylindrical shell 16. The drum 12 also includes a second radially extending drum end wall (not shown) opposite the first drum end wall 14 and connected to the cylindrical shell 16 to create a sealed enclosure within the drum 12. A motor (not shown) may be coupled to the drum 12 for driving rotation of the drum 12. A plurality of axially extending bars 17 may be mounted on an inside wall 23 of the drum shell 16 to create more turbulence of the condensate and enhance heat transfer to the drum 12. The bars 17 stop short of reaching the drum end wall 14. The drum 12 is connected to the rotary joint 10 by a drum journal 18 which is connected to and extends through the drum end wall 14 of the drum 12. A syphon 20 extends from the rotary joint 10, through the drum journal 18, and into the interior of the drum 12, wherein the syphon 20 has an intake or inlet port 22 that is positioned adjacent the inner wall 23 of the drum shell 16 between the drum end wall 14 and the bars 17 for syphoning out condensate formed in the interior of the drum 12. An adjustment mechanism 24 housed in the rotary joint 10 provides for adjustment of the syphon 20 such that the syphon inlet port 22 may be accurately positioned adjacent the inner wall 23 of the drum shell 16 to remove the proper amount of condensate from the drum 12. During the paper manufacturing process, the syphon 20 remains stationary, less any adjustable movement of the syphon 20 by the adjustment mechanism 24, while the drum 12 rotates, and a paper or cardboard web (not shown) is heated by passing over the exterior of the drum shell 16 and absorbing the heat of the drum 12. If the level of condensate is not properly maintained within the drum 12, the temperature and rotational speed of the drum 12 may not be properly maintained for drying the paper or cardboard web.

The purpose of the rotary joint 10 is to connect a stationary inlet 26 and a stationary outlet 28 to the rotating drum 12 in a sealed and pressurized manner. As seen in FIGS. 1-4, the rotary joint 10 includes the stationary portion 11 having a head 29, the adjustment mechanism 24, a stationary body 30, and a stationary bracket 32, and the rotating portion 13 having a rotating body 31 and the drum journal 18 which is connected to the drum 12. The stationary body 30 has a substantially cylindrical configuration with an integral flange 33 extending radially outward from a front side of the stationary body 30. The front side of the stationary body 30 is connected to a back side of the substantially cylindrical stationary bracket 32 using conventional fasteners, such as bolts and nuts 34, that extend through bores extending through the flange 33 of the stationary body 30 and into closed ended apertures provided in the stationary bracket 32, wherein the stationary bracket 32 houses the rotating body 31. In a nonlimiting disclosure, eight bolts and eight nuts 34 may be utilized to connect the stationary body 30 to the stationary bracket 32. The stationary body 30 includes a hollow chamber 36 formed within the stationary body 30 and in communication with the stationary inlet 26 that opens into an outer periphery of the stationary body 30. The inlet 26 may communicate with certain piping or tubing (not shown) for receiving pressurized steam, water, and/or air from a pressurized source (not shown). The inlet 26 is in communication with an inlet passageway 40 that extends through the chamber 36 of the stationary body 30, the rotating body 31, the drum journal 18, and into the interior of the drum 12. A primary syphon tube or pipe 42 of the syphon 20 extends substantially horizontal and has a first end 51 and a second end 53 wherein the first end 51 is located within the adjustment mechanism 24, and the second end 53 is located within the drum journal 18. The primary syphon tube 42 extends from the first end 51 to the second 53 and is disposed within the inlet passageway 40. The primary syphon tube 42 has a cylindrical structure with a through bore 47 extending through the primary syphon tube 42 along a longitudinal axis of the primary syphon tube 42. The primary syphon tube 42 is fabricated from a substantially rigid, high-strength material. In a nonlimiting disclosure, the material may be fabricated from a metallic material, such as steel. The outer and inner diameters of the primary syphon tube 42 are substantially constant throughout the primary syphon tube 42 less the first end 51 of the primary syphon tube 42 as will be described later. The inlet passageway 40 in the stationary body 30 is larger than the outer diameter of the primary syphon tube 42 thereby allowing the inlet passageway 40 to communicate steam, water, and/or air outside the primary syphon tube 42 from the inlet 26 of the stationary body 30 to the rotating portion 13.

To allow for sealed rotation of the rotating body 31 relative to the stationary body 30, a reciprocal cylindrical piston 44 is housed within the chamber 36 of the stationary body 30. The piston 44 has a stem 43 and a head 41 wherein the head 41 extends integrally and radially outward from one end of the stem 43. Movement of the piston 44 is guided by a plurality of piston pins 45, wherein each piston pin 45 has a stem and a head wherein the head extends integrally and radially outward from one end of the stem. In a nonlimiting disclosure, two piston pins 45 may be utilized to guide the piston 44. The stems of the piston pins 45 are received by through bores extending through the head 41 of the piston 44, wherein the head of the piston pins 45 is larger than the through bores provided in the head 41 of the piston 44 such that the heads of the piston pins 45 engage and are welded to the head 41 of the piston 44 to prevent the piston pins 45 from passing through the head 41 of the piston 44. The stems of the piston pins 45 are received by and disposed within blind bores provided in the stationary body 30. At least one compression spring 56 is seated between the head 41 of the piston 44 and a shoulder formed in the chamber 36 of the stationary body 30 wherein the at least one compression spring 56 is positioned radially between the stem of the piston pins 45 and an outer surface of the stem 43 of the piston 44. In a nonlimiting disclosure, six compression springs 56 may be utilized to bias the piston 44. The head 41 of the piston 44 has a flat end surface 46 that engages a flat end surface of an annular seal ring 48. A conical surface formed on an opposite side of the annular seal ring 48 from the flat end surface is provided for engaging a conical surface formed on a rotating annular wear plate 49 of the rotating body 31 housed within the stationary bracket 32. As the seal ring 48 wears due to rotation of the wear plate 49, the at least one compression spring 56 biases and moves the end surface 46 of the piston 44 against the seal ring 48 ensuring continual engagement of the piston 44, the seal ring 48, and the wear plate 49. Since the piston 44 may move along a longitudinal axis of the stationary body 30 caused by the wearing of the seal ring 48, a pair of annular flexible seals 59 are positioned between the stem 43 of the piston 44 and an inner wall of the stationary body 30 defining the chamber 36. The pair of flexible seals 59 are seated within annular grooves formed in the outer surface of the stem 43 of the piston 44.

As previously noted, the stationary bracket 32 is connected to and extends from the stationary body 30, wherein the stationary bracket 32 has a substantially cylindrical configuration to house the rotating body 31 which includes the wear plate 49 and a portion of the seal ring 48. The wear plate 49 is connected to an annular journal flange 50 of the rotating body 31 using conventional fasteners, such as bolts 52, wherein the journal flange 50 is housed within the stationary bracket 32. In a nonlimiting disclosure, six bolts 52 may be utilized to connect the wear plate 49 to the journal flange 50. A gasket 55 is positioned between the opposing surfaces of the wear plate 49 and the journal flange 50 to provide a sealed connection. The journal flange 50 is in turn connected to the drum journal 18 through conventional fasteners, such as bolts 54. In a nonlimiting disclosure, six bolts 54 may be utilized to connect the journal flange 50 to the drum journal 18. A gasket is also positioned between the opposing surfaces of the journal flange 50 and the drum journal 18 to provide a sealed connection. The drum journal 18 extends outwardly from the journal flange 50 from just within the stationary bracket 32, through the drum end wall 14, and into the drum 12. The drum journal 18 is connected to the drum 12 in a sealed manner by welding, pressing, or other conventional methods. The above noted connections allow the wear plate 49 to rotate with the journal flange 50, the drum journal 18, and the drum 12. The seal ring 48, the wear plate 49, the journal flange 50, and the drum journal 18 all have annular configurations such that through bores extend along their longitudinal axes to receive the horizontal primary syphon tube 42 and provide a sufficient amount of space in the through bores to allow for the inlet passageway 40 to pass steam, water, and/or air outside the primary syphon tube 42, through the rotary portion 13, and into the drum 12.

To house the adjustment mechanism 24 for adjusting the position of the syphon 20, the stationary body 30 of the rotary joint 10 provides a substantially flat outer end surface at the opposite end of the stationary body 30 that connects to the rotating portion 13 against which an annular housing 60 of the adjustment mechanism 24 is connected thereto, as seen in FIGS. 1, 3, 4, 5A, 5B, and 6. The housing 60 has a substantially flat front end surface that engages the end surface of the stationary body 30, and a gasket 62 and an annular seal 64, seated within a recess in the end surface of the stationary body 30, are positioned between the stationary body 30 and the housing 60 to provide a sealed and fluid tight connection. The chamber 36 of the stationary body 30 opens into the flat outer surface of the stationary body 30 and is in fluid communication with a through bore provided in the annular housing 60 of the adjustment mechanism 24 for receiving and housing the primary syphon tube 42. The primary syphon tube 42 is keyed against rotation relative to the stationary body 30 by a key 66 which is connected to the outer diameter of the primary syphon tube 42 and engages a keyway 67 extending outward form the housing 60.

In order to support the first end 51 of the primary syphon tube 42, an annular retainer plate 68 having a through bore extending along a longitudinal axis of the retainer plate 68 is connected and adjacent to the housing 60 of the adjustment mechanism 24. A gasket 69 is provided between the adjoining substantially flat surfaces of the retainer plate 68 and the housing 60 to provide a sealed and fluid tight connection. An annular syphon adjustment ring 72 is disposed between the housing 60 of the adjustment mechanism 24 and the retainer plate 68, wherein the housing 60 provides an annular recess for receiving and housing the syphon adjustment ring 72. The annular recess in the housing 60 is larger than the syphon adjustment ring 72 to allow for movement of the syphon adjustment ring 72 within the annular recess in the housing 60. A pair of annular flexible O-rings 73 are seated in annular grooves provided in the housing 60 and the retainer plate 68 to allow for a sealed connection between the syphon adjustment ring 72 and the housing 60 and between the syphon adjustment ring 72 and the retainer plate 68. The retainer plate 68 provides a stepped through bore for receiving the first end 51 of the primary syphon tube 42. A T-shaped nut 74 having a through bore extending along a longitudinal axis of the nut 74 has threads formed on the outer diameter of the nut 74 that threadedly engage threads formed on the inner diameter of the first end 51 of the primary syphon tube 42. The primary syphon tube 42 tapers downward toward the outer diameter of the first end 51 of the primary syphon tube 42, and the tapered surface on the primary syphon tube 42 engages a corresponding tapered surface on an inner diameter of the syphon adjustment ring 72. An annular spacer 76 positioned between the syphon adjustment ring 72 and the nut 74 spaces the nut 74 from the syphon adjustment ring 72, thereby maintaining a wedging effect between the tapered surfaces of the primary syphon tube 42 and the syphon adjustment ring 72. The nut 74 further supports the engagement of the tapered surfaces of the primary syphon tube 42 and the syphon adjustment ring 72 by threading into the inside diameter of the first end 51 of the primary syphon tube 42, thereby forcing the tapered surfaces of the primary syphon tube 42 and the syphon adjustment ring 72 to remain engaged. As described, the spacer 76 and the nut 74 assist in securing a tight and rigid connection between the tapered surfaces of the primary syphon tube 42 and the syphon adjustment ring 72 such that the primary syphon tube 42 remains rigid and substantially parallel to the longitudinal axis of the rotary joint 10. This rigid connection allows the adjustment mechanism 24 to adjust the position of the inlet port 22 in the syphon 20 by moving the first end 51 of the primary syphon tube 42, as will be described later.

To syphon the condensate out from the drum 12 and through the rotary joint 10, the head 29 of the stationary portion 11 has a substantially flat front face or surface that is connected to a rear substantially flat surface of the retainer plate 68. A gasket 78 is placed between the front face of the head 29 and the rear surface of the syphon support 68 to provide a sealed connection. A plurality of conventional fasteners, such as bolts 80, extend through bores provided in the head 29 and the retainer plate 68 and into blind threaded bores provided in the housing 60 of the adjustment mechanism 24 to connect the head 29, the retainer 68, and the housing 60 together. In a nonlimiting disclosure, four bolts 80 may be utilized to secure the head 29, the retainer plate 68, and the housing 60 together. The head 29 further provides a portion of an outlet passageway 82 that extends from the front face of the head 29 to the stationary outlet 28 which opens into a bottom periphery of the head 29. The outlet passageway 82 is in communication with the bore extending through the primary syphon tube 42. The stationary outlet 28 in the head 29 may be connected to various tubing or piping which may be connected to a vacuum source for drawing the condensate from the drum 12 and through the outlet passageway 82 to the stationary outlet 28 wherein the condensate may be directed to an appropriate drain or recycling mechanism (not shown).

The primary syphon tube 42 extends from the head 29 of the rotary joint 10 to an open end of the drum journal 18, as seen in FIG. 1. Because the primary syphon tube 42 is pre-assembled into the rotary joint 10, the primary syphon tube 42 is inserted into the drum journal 18 for connection to a secondary syphon tube 90 which extends substantially vertically downward. A two-piece, 90 degree angled elbow 88 having a passageway extending therethrough has a first end 91 connected to the second end of the primary syphon tube 42 and a second end 93 connected to a first end of the secondary syphon tube 90. The first and second ends 91, 93 of the elbow 88 fit together to form the 90 degree elbow 88 wherein a conventional fastener 95 threads into the first and second ends 91, 93 of the elbow 88 to secure the elbow 88 in position and allow for the condensate to flow through the secondary syphon tube 90, the elbow 88, and the primary syphon pipe tube 42. It should be noted that the present disclosure is not limited to the elbow 88 as described, but rather, any adjustable or two-piece connection that provides a rigid connection between the primary syphon 42 and the secondary syphon tube 90 and allows the inner bores of the primary syphon tube 42 and the secondary syphon tube 90 to communicate while assembled in the drum 12 is anticipated. The primary syphon tube 42 and the secondary syphon tube 90 are rigidly connected to sufficiently allow the primary syphon tube 42 and the secondary syphon tube 90 to rigidly move in concert upon the adjustment mechanism 24 moving the primary syphon tube 42 fore and aft of the longitudinal axis of the rotary joint 10 thereby moving the secondary syphon tube 90 vertically along its longitudinal axis to adjust the distance between the syphon inlet port 22 and the inside surface of the drum shell 16.

To connect the secondary syphon tube 90 to the elbow 88, the first end 91 of the elbow 88 is connected to and extends from the second end of the primary syphon tube 42 into the drum 12 and away from the drum journal 18, and the second end 93 of the elbow 88 is connected to and extends vertically downward to the first end of the secondary syphon tube 90. The secondary syphon tube 90 extends vertically downward from the first end to a second end of the secondary syphon tube 90. The second end of the secondary syphon tube 90 has a two-piece snap fitting 95 wherein a first end 97 of the snap fitting 95 is press fit on the secondary syphon tube 90 in a sealed manner. A second end 99 of the snap fitting 95 slides over the second end of the secondary syphon tube 90 wherein biased tabs snap over one another to engage and connect the first and second ends 97, 99 of the snap fitting 95. The second end of the snap fitting 95 is close ended with through slots formed in the sides of the bottom of the second end 99 of the snap fitting 95. The slots are in communication with the end of the secondary syphon tube 90 and form the syphon inlet port 22 for receiving the condensate formed at the bottom of the drum shell 16. It should be noted that the present disclosure is not limited to the snap fitting 95 as described, but rather, any fitting that provides an appropriate inlet port 22 at the bottom of the secondary syphon tube 90 may be utilized. The secondary syphon tube 90 has a cylindrical configuration with a through bore extending the length of the secondary syphon tube 90, similar to the primary syphon tube 42. The secondary syphon may be fabricated from a substantially rigid, high strength material, similar to the primary syphon tube 42. In a nonlimiting disclosure, the secondary syphon tube 90 may be fabricated from a metallic material, such as steel. The condensate may travel through the outlet passageway 82 created and defined by the through the bore in the secondary syphon tube 90, the bore in the elbow 88, the bore in the primary syphon tube 42, and the stationary outlet 28, wherein the condensate is removed and discarded.

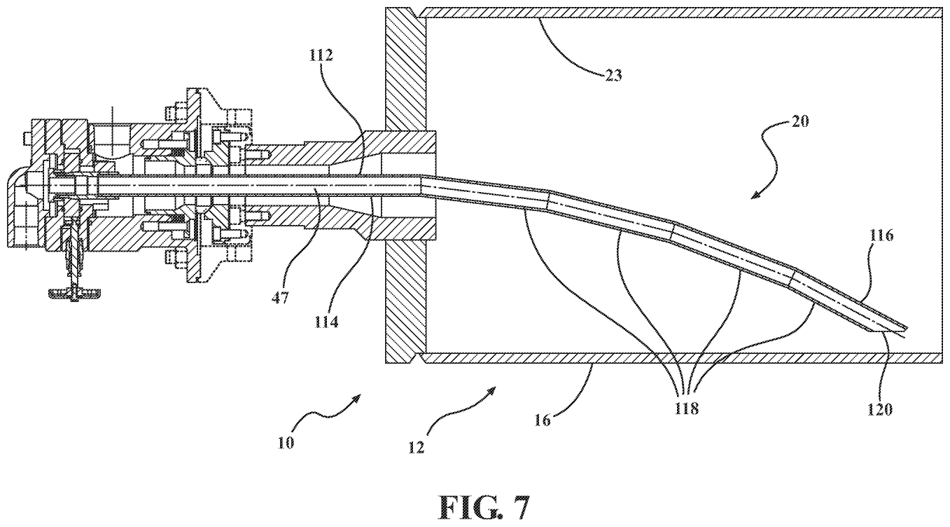

In another embodiment, the syphon 20 may provide a one-piece syphon tube 112, as shown in FIG. 7. The syphon tube 112 has a cylindrical configuration and may have a horizontal primary portion 114, similar to the primary syphon tube 42, and a bent portion 116 that extends integrally away from the primary portion 114 of the syphon tube 112 within the drum 12 to provide the outlet passageway 47, as described herein. In a nonlimiting disclosure, the bent portion 116 of the syphon tube 112 may have four bends which allow for four linear segments 118 forming the bent portion 116 of the syphon tube 112. It should be noted that any number of bends or radiused segment may be used to define the bent portion 116 of the syphon tube 112. The bent portion 116 of the syphon tube 112 extends toward the inner surface 23 of the drum 12 wherein a free end 120 of the bent portion 116 of the syphon tube 112 is optimally positioned adjacent the inner surface 23 of the drum 12. Because of the angled or radiused structure of the bent portion 116 of the syphon tube 112, the free end 120 of the syphon tube 112 is angled to be substantially parallel to the inner surface 23 of the drum 12. Although not shown, the free end 120 of the bent portion 116 of the syphon tube 12 may have a similar fitting, such as the snap fitting 95, connected thereto. The snap fitting 95 may provide a closed end and an inlet port 22 formed in the sides of the snap fitting 95 to prevent the open end of the syphon tube 112 from contacting the inner surface 23 of the drum 12. Since the bent portion 116 of the syphon tube 112 is integrally connected to and extending from the primary portion 114 of the syphon tube 112, and since the syphon tube 112 is fabricated from a rigid material, the position of the inlet port 22 in the syphon tube 112 relative to the inner surface 23 of the drum 12 may be adjusted by the adjustment mechanism 24 in the same manner as described herein.

To adjust the position of the syphon inlet port 22 relative to the inside diameter of the drum shell 16, the adjustment mechanism 26 may provide an adjuster 89 that is at least partially housed within a stepped bore extending from the periphery of the housing 60 and having a longitudinal axis substantially perpendicular to the longitudinal axis of the housing 60, as seen in FIGS. 1, 3-6. The stepped bore in the periphery of the housing 60 extends into the stepped bore provided within the center of the annular housing 60. The adjuster 89 may comprise various structures that allow the adjuster 89 to extend through the stepped bore in the housing 60 and be coupled to the adjuster ring 72 for adjustably moving the position of the adjuster ring 72. Reciprocal movement of the adjuster 89 will in turn provide reciprocal movement of the adjustment ring 72 in a direction transverse to the longitudinal axis of the rotary joint 10. Since the adjustment ring 72 is connected to the primary syphon tube 42 as previously described, reciprocal movement of the adjustment ring 72 will also provide reciprocal movement of the primary syphon tube 42 in a direction fore and aft of the longitudinal axis of the rotary joint 10 which in turn will move the secondary syphon tube 90 vertically to adjust the distance between the syphon inlet port 22 and the inner surface of the drum shell 16.

In one embodiment, the adjuster 89 may comprise an adjusting screw 92 that extends through the counter-bore provided in the periphery of the housing 60 and threadedly engages at least a portion of the counter-bore. A free end of the adjusting screw 92 extends outwardly away from the housing 60 and has a knob handle 94 attached thereto by a conventional fastener, such as a screw 96. The opposite end of the adjusting screw 92 has a narrow neck portion 104 with a larger end or head 98 extending from and integral with the neck portion 104. The neck portion 104 is inserted through a slot 102 provided in the side of the adjustment ring 72. The slot 102 is in communication with a through bore 100 that extends through the adjustment ring 72 substantially parallel to the longitudinal axis of the housing 60 such that the head 98 of the adjusting screw 92 is captured within the through bore 100 and cannot pass through the slot 102 of the adjustment ring 72 which is smaller than the head 98 of the adjusting screw 92. To provide a sealed connection between the adjustment screw 92 and the housing 60, the adjustment screw 92 is further supported in the housing 60 by a packing box 104 which receives the adjustment screw 92 and is partially housed and press fit within the counter bore in the periphery of the housing 60. A packing bushing 106, a pair of bull rings 108, and two packing rings 110 disposed between the pair of bull rings 108 receive the adjustment screw 92 and are seated and stacked within the packing box 104. A packing nut 110 receives the adjustment screw and is connected to the end of the packing box 104 to secure the packing bushing 106, the pair of bull rings 108, and the two packing rings 110 within the packing box 104 while allowing the adjustment screw 92 to extend outwardly away from the packing box 104. By rotating the knob handle 94, the mating threads on the adjustment screw 92 and the counter bore may drive the adjustment screw 92 inwardly and outwardly from the periphery of the housing 60 thereby moving the adjustment ring 72 in a direction substantially perpendicular to the longitudinal axis of the rotary joint 10.

As previously described, the primary syphon tube 42 and the adjustment ring 72 are rigidly connected and share a coaxial longitudinal axis. When the adjustment screw 92 moves the adjustment ring 72, the coaxial longitudinal axis of the adjustment ring 72 and the primary syphon tube 42 move fore and aft of the longitudinal axis of the rotary joint 10. Due to the primary syphon tube 42 being rigidly supported by the adjustment ring 72, and due to the elbow 88 rigidly connecting the primary syphon pipe 42 to the secondary syphon pipe 90, when the longitudinal axis of the primary syphon tube 42 moves fore and aft of the longitudinal axis of the rotary joint 10, the secondary syphon tube moves vertically or substantially perpendicular to the longitudinal axis of the rotary joint 10, thereby moving the syphon inlet port 22 closer to or farther away from the inside surface of the drum shell 16. Since the syphon 20 is sealed within the rotary joint 10 and the drum 12, and since the adjustment mechanism 24 may be adjusted by turning the adjustment knob 94 from outside the rotary joint 10, the distance from the syphon inlet port 22 and the inside surface of the drum shell 16 may be adjusted without having to stop the rotation of the drum 12 and without having to depressurize the rotary joint 10 and the drum 12. This increases the efficiency of the paper manufacturing process as the distance between the syphon inlet port 22 and the inner surface of the drum shell 16 may be adjusted to optimize the amount of condensate removed from the drum 12 without having to stop or pause the paper manufacturing process.

In operation, the rotary joint 10 is connected to the drum journal 18, which is fixedly connected to drum 12, by inserting the primary syphon tube 42 into the drum journal 18 and connecting the rotary joint 10 to the drum journal 18 with conventional fasteners, as previously described. By accessing the inside of the drum 12, the first and second parts 91, 93 of the elbow 88 may be connected to assemble the primary syphon tube 42 to the secondary syphon tube 90 at a substantial right angle. The distance between the syphon inlet port 22 and the inner surface of the drum shell 16 is initially set at a predetermined distance. In a nonlimiting disclosure, the initial distance between the bottom of the snap fitting 95 and the inner surface of the drum shell 16 may be initially set at 6.70 mm. The initial distance between the syphon inlet port 22 and the inner surface of the drum shell 16 can be set by adjusting the length of the secondary syphon tube 90 or using the adjustment mechanism 24 once the secondary syphon tube 90 is connected to the primary syphon tube 42. However, once the drum 12 starts to rotate in operation, the preset distance may initially be too great based on manufacturing tolerances of the drum 12, the connections with the rotary joint 10, the assembly of the syphon 20, and the rotation of the drum 12. During the paper manufacturing process, the drum 12 rotates and a certain amount of condensate forms in the drum 12 thereby affecting the temperature and rotational speed of the drum 12. If a sufficient amount of condensate is not removed to maintain the temperature and rotational speed of the drum 12, the distance from the syphon inlet port 22 to the inner surface of the drum shell 16 may be altered by turning the knob 94 on the adjustment mechanism 24. This process may continue until the proper temperature and rotational speed of the drum 12 is maintained. The adjustment can be made while the paper manufacturing process is operating, and thus, the drum 12 need not be stopped or depressurized. This enhances the efficiency of the paper manufacturing process since the paper manufacturing process need not be stopped or paused to adjust the amount of condensate removed from the drum 12.

While the disclosure has been made in connection with what is presently considered to be the most practical and preferred embodiment, it should be understood that the disclosure is intended to cover various modifications and equivalent arrangements described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

What is claimed is:

1. A rotary joint connecting a stationary portion to a rotating portion for communicating a pressurized fluid to a rotating drum, comprising:
an inlet passageway extending through the stationary portion and the rotating portion for directing the pressurized fluid to inside the rotating drum;
a syphon tube disposed within the stationary portion and the rotating portion and in communication with a vacuum source, the syphon tube having an inlet port positioned within the rotating drum;
an outlet passageway extending through the syphon tube and in communication with an outlet in the stationary portion and the inlet port in the syphon tube for removing condensate from the rotating drum; and
an adjustment mechanism at least partially disposed within and outside the stationary portion for adjusting the distance between the inlet port of the syphon tube and an inner surface of the rotating drum without the need for stopping the rotation of the rotating drum and/or depressurizing the drum.

2. The rotary joint stated in claim 1, wherein the syphon tube is stationary.

3. The rotary joint stated in claim 2, wherein the syphon tube further comprises:
a primary syphon tube extending through the stationary portion and at least a portion of the rotating portion and having a longitudinal axis parallel to a longitudinal axis of the stationary portion; and
a secondary syphon tube in communication with the primary syphon tube wherein the secondary syphon tube has an inlet port located within the rotating drum.

4. The rotary joint stated in claim 1, further comprising:
at least a portion of the syphon tube disposed within the inlet passageway.

5. The rotary joint stated in claim 1, wherein the adjustment mechanism further comprises:
an annular adjustment ring housed within the stationary portion and moveable in a direction transverse to a longitudinal axis of the stationary portion;
the adjustment ring coupled to the syphon tube; and
an adjuster at least partially disposed within the stationary portion and coupled to the adjustment ring wherein the adjuster may reciprocally move the adjustment ring and the syphon tube transverse to the longitudinal axis of the stationary portion thereby reciprocally adjusting the distance between the inlet port of the syphon tube and the inner surface of the rotating drum.

6. The rotary joint stated in claim 3, wherein the adjuster further comprises:
an adjustment screw threadedly engaging a bore in the stationary portion wherein reciprocal rotation of the adjustment screw reciprocally moves the adjustment ring and the syphon tube transverse to the longitudinal axis of the stationary portion thereby reciprocally adjusting the distance between the inlet port of the syphon tube and the inner surface of the rotating drum.

7. The rotary joint stated in claim 6, further comprising:
the adjustment screw having an outwardly extending portion extending outwardly away from the stationary portion; and
a knob connected to the outwardly extending portion of the adjustment screw to allow for reciprocal rotation of the adjustment screw by a user.

8. The rotary joint stated in claim 5, further comprising:
the adjustment ring having a through bore and a slot extending along a longitudinal axis parallel to the longitudinal axis of the adjustment ring; and
the adjuster having a neck formed thereon and a head integral with and larger than the neck formed on a free end of the adjuster, wherein the neck is received by the slot of the adjustment ring, and the head is received by the through bore in the adjustment ring to capture the head in the adjustment ring allowing the adjuster to connect to the adjustment ring for reciprocal movement of the adjustment ring.

9. The rotary joint stated in claim 4, further comprising:
the adjustment ring having a conical surface formed on an inside diameter of the adjustment ring; and
the syphon tube having a conical surface formed on the outside diameter of the syphon tube wherein the conical surface on the syphon tube complementarily engages the conical surface on the adjustment ring.

10. The rotary joint stated in claim 8, further comprising:
a nut having a threaded outside diameter for threadedly engaging threads on an inner diameter of the syphon tube wherein the threads on the inside diameter of the syphon tube are adjacent the conical surface formed on the outside diameter of the syphon tube to maintain engagement of the conical surfaces on the adjustment ring and the syphon tube.

11. The rotary joint stated in claim 9, further comprising:
a flange integral with and extending radially outward from the nut; and
a spacer positioned between and engaging the flange of the nut and the adjustment ring to maintain engagement of the conical surfaces of the syphon tube and the adjustment ring.

12. A rotary joint connecting a stationary portion to a rotating portion for communicating a pressurized fluid to a rotating drum, comprising:
an inlet passageway extending through the stationary portion and the rotating portion for directing pressurized fluid to inside the rotating drum;
a primary syphon tube disposed within the inlet passageway of the stationary portion and the rotating portion, and a secondary syphon tube and in communication with the primary syphon tube and disposed within the drum, wherein the secondary syphon tube has an inlet port positioned within the rotating drum;
an outlet passageway extending through the primary syphon tube and the secondary syphon tube, and one end of the outlet passageway in communication with a vacuum source and the other end of the outlet passageway in communication with the inlet port of the secondary syphon tube for removing condensate from the rotating drum; and
an adjustment mechanism coupled to the primary syphon tube for adjusting the distance between the inlet port of the secondary syphon tube and an inner surface of the rotating drum without the need for stopping the rotation of the drum and/or depressurizing the drum.

13. The rotary joint stated in claim 12, wherein the stationary portion further comprises:
a stationary body;
the adjustment mechanism connected to the body; and
a stationary head connected to the adjustment mechanism.

14. The rotary joint stated in claim 12, wherein the rotating portion further comprises:
a rotating wear plate;
a rotating journal flange connected to the wear plate; and
a rotating drum journal connected to the journal flange.

15. The rotary joint stated in claim 13, wherein the adjustment mechanism further comprises:
an annular stationary housing connected to the body;
an annualar syphon retainer plate connected to the housing and the head;
an annular adjustment ring coupled to the primary syphon pipe and movably disposed with the housing; and
an adjuster partially disposed and movable within the housing and coupled to the adjustment ring wherein movement of the adjuster correspondingly moves the adjustment ring and the primary syphon ring to adjust the position of the inlet port in the secondary syphon tube relative to the inside surface of the rotating drum.

16. The rotary joint in claim 15, wherein the adjuster further comprises:
an adjustment screw threadedly engaging a bore in the housing, wherein a first end of the adjustment screw is coupled to the adjustment ring, and a second end of the adjustment screw extends outward from the housing to allow for adjustment of the position of the primary syphon tube and the secondary syphon tube without the need for stopping the drum.

17. The rotary joint in claim 16, further comprising:
a packing box at least partially disposed within the counter bore in the housing for receiving the adjustment screw;
at least one bushing and packing ring seated within the packing box and receiving the adjustment screw to provide a sealed connection between the adjustment screw and the housing; and
a packing nut connected to the packing box and receiving the adjustment screw for securing the at least one bushing and packing ring within the packing box.

18. The rotary joint in claim 15, further comprising:
the adjustment ring having a conical surface for engaging a conical surface on an outside diameter of the primary syphon tube;
a threaded nut for threadedly engaging an inside diameter of the primary syphon tube to maintain engagement between the conical surface of the adjustment ring and the conical surface of the primary syphon tube; and
a spacer for engaging the nut and the adjustment ring for further maintaining engagement of the conical surface of the adjustment ring and the conical surface of the primary syphon tube.

19. The rotary joint in claim 13, further comprising:
the head having an outlet in communication with the primary syphon tube wherein the outlet is in communication with an outlet port opening into a periphery of the head for directing condensate away from the rotary joint and the rotating drum.

20. A rotary joint, comprising:
a stationary body having an inlet for receiving a pressurized fluid from a pressurized fluid source;
a rotating body connected to the stationary body and a rotating enclosed drum;
an inlet passageway extending from the inlet of the stationary body, through the stationary body and the rotating body, and into the rotating drum for directing the pressurized fluid to the rotating drum;
a stationary adjustment mechanism connected to the stationary body and operable from outside the stationary body and the rotating body;
a stationary head connected to the adjustment mechanism and having an outlet for directing condensate away from the rotary joint and the rotating drum;
a stationary syphon tube disposed within and extending through the stationary body, the adjustment mechanism, the head, and the rotating body, and the syphon tube having an inlet port positioned within the rotating drum;
an outlet passageway extending through the syphon tube and in communication with the inlet port of the syphon tube and the outlet of the head, the outlet of the head in communication with a vacuum source for removing condensate from the rotating drum; and
the stationary adjustment mechanism coupled to the syphon tube for adjusting the distance between the inlet port in the syphon tube and an inside surface of the drum without the need for stopping the rotation of the drum.
